(19) United States
(12) Patent Application Publication
(10) Pub. No.: US 2014/0345137 A1
(43) Pub. Date: Nov. 27, 2014

(54) METHOD FOR MANUFACTURING FLAT HEAT PIPE WITH SECTIONAL DIFFERENCES

(71) Applicant: COOLER MASTER DEVELOPMENT CORPORATION, New Taipei City (TW)

(72) Inventors: Chang-Yin CHEN, NEW TAIPEI CITY (TW); Lei-Lei LIU, NEW TAIPEI CITY (TW); Lin-Chuan YEN, NEW TAIPEI CITY (TW)

(21) Appl. No.: 14/457,243

(22) Filed: Aug. 12, 2014

Related U.S. Application Data
(62) Division of application No. 13/415,703, filed on Mar. 8, 2012.

(51) Int. Cl. B23P 15/26

(52) U.S. Cl. CPC B23P 15/26; B23P 2700/09
USPC 29/890.032

(57) ABSTRACT

A method for manufacturing a flat heat pipe with sectional differences includes following steps. First, form a plurality of grooves on an inner wall of a pipe body having one outer diameter. Subsequently, form a plurality of tubular sectional difference portions having various outer diameters on the pipe body. Then, degass an interior of the pipe body into vacuum and seal both ends thereof. Finally, press the respective sectional difference portions of the pipe body into flat.

### CROSS-REFERENCE TO RELATED APPLICATIONS

This application is a Divisional Applications of U.S. application Ser. No. 13/415,703 filed on Mar. 08, 2012. The entire disclosure is incorporated herein by reference.

### BACKGROUND OF THE INVENTION

1. Field of the Invention

The present invention relates to a heat pipe and a method for manufacturing the same, and in particular to a flat heat pipe with sectional differences in its width direction and a method for manufacturing the same.

2. Description of Prior Art

When the traditional tubular heat pipe is to be applied in an electronic element for heat dissipation or applied in a place with a limited height, the tubular heat pipe has to be made flat. In addition, after the tubular heat pipe is pressed flat, the flat surface is brought into thermal contact with a heat source in a surface-to-surface contact relationship. The thus-formed contact area is larger, so that the heat transfer efficiency of the flat heat pipe is better.

After the traditional tubular heat pipe is sealed at its ends, since the wick structure disposed in the heat pipe is often formed of sintered powder or metallic meshes, such a wick structure will make the flattening process of the heat pipe unsmooth. Further, since the outer diameter of the traditional tubular heat pipe is smaller, usually from 6 mm to 8 mm or so, the width of the thus-formed flat heat pipe is not large enough to cover the surface of a desired heat-generating element completely.

In view of the above, the present Inventor proposes a novel and reasonable structure based on his expert knowledge and deliberate researches.

### SUMMARY OF THE INVENTION

The present invention is to provide a method for manufacturing the same. The inner wall of a pipe body of the tubular heat pipe is formed with a plurality of grooves in which a wick structure is formed. Further, the pipe body is integrally formed with a plurality of sectional difference portions having different outer diameters respectively. By this structure, when the pipe body is pressed flat, the wick structure formed in the grooves will not suffer damage. Further, since the pitches between the grooves in the respective sectional difference portions are different, an evaporating portion and a heat-transmitting portion of the heat pipe can be reinforced based on practical demands.

The present invention provides a flat heat pipe with sectional differences, which has a flat hollow pipe body. A working fluid is sealed in the pipe body. The pipe body is provided along its length with a plurality of flat sectional difference portions having different widths. A connecting portion is formed between the sectional difference portions. The inner wall of the pipe body is formed with a plurality of grooves. The pitch between the grooves in the sectional difference portion of a relatively large width is larger than the pitch between the grooves in the sectional difference portion of a relatively small width.

The present invention provides a method for manufacturing a flat heat pipe with sectional differences, including steps of:

a) draw-forming a tubular hollow pipe body, the pipe body having one outer diameter, forming a plurality of grooves on an inner wall of the pipe body;

b) making the pipe body to have a plurality of outer diameters along its length to thereby form a plurality of tubular sectional difference portions on the pipe body;

c) degassing the interior of the pipe body into vacuum and sealing both ends of the pipe body; and

(d) pressing the respective sectional difference portions of the pipe body into flat.

### BRIEF DESCRIPTION OF DRAWING

FIG. 1 is a schematic view of showing the external appearance of the flat heat pipe of the present invention;

FIG. 2 is a cross-sectional view taken along the line 2-2 in FIG. 1;

FIG. 3 is a cross-sectional view taken along the line 3-3 in FIG. 1;

FIG. 4 is a flow chart showing the method for manufacturing the flat heat pipe of the present invention;

FIG. 5 is a schematic view showing the pipe body formed in a step Si of FIG. 4;

FIG. 6 is a schematic view showing the pipe body formed in a step S2 of FIG. 4;

FIG. 7 is a schematic view showing the pipe body formed in a step S3 of FIG. 4; and

FIG. 8 is a schematic view showing the internal structure of the flat heat pipe with sectional differences according to another embodiment of the present invention.

### DETAILED DESCRIPTION OF THE INVENTION

In order to make the Examiner to better understand the characteristics and technical contents of the present invention, the detailed description relating thereto will be made with reference to the accompanying drawings. However, the drawings are illustrative only, but not used to limit the scope of the present invention.

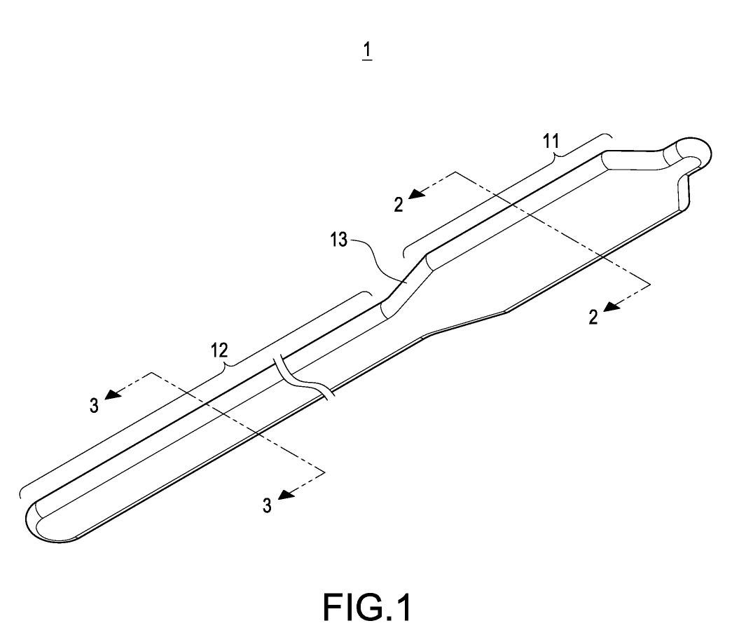

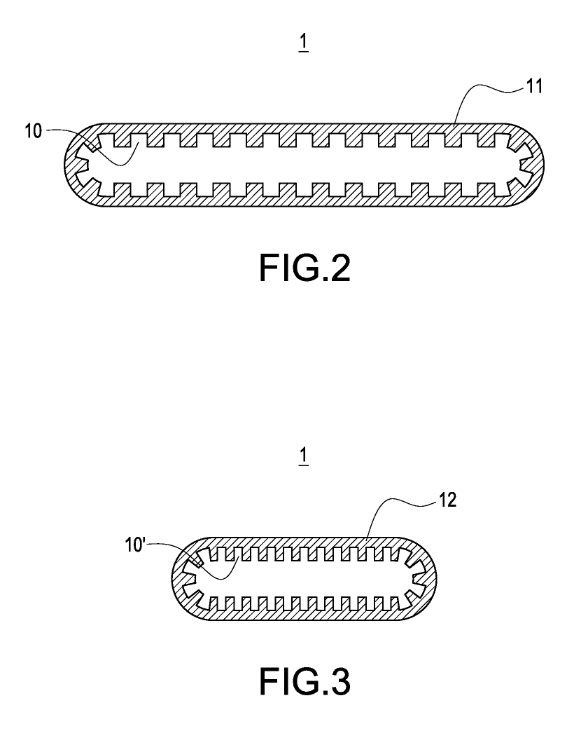

Please refer to FIG. 1, which is a schematic view showing the external appearance of the flat heat pipe with sectional differences according to the present invention. The present invention provides a flat heat pipe with sectional differences and a method for manufacturing the same. The flat heat pipe of the present invention has a flat hollow pipe body 1. A working fluid (not shown) is sealed in the pipe body 1. The pipe body 1 is provided along its length with at least two flat sectional difference portions 11, 12 of different widths. A sectional difference is formed between the sectional difference portions 11, 12 in the width direction of the pipe body 1. A connecting portion 13 is integrally formed between the sectional difference portions 11, 12. Please also refer to FIGS. 2 and 3. The inner wall of the pipe body 1 is formed with a plurality of grooves 10, 10′. The pitch between the grooves 10 in the section difference portion 11 of a relatively large width is larger than the pitch between the grooves 10′ in the sectional difference portion 12 of a relatively small width.

According to the above, in the present embodiment of the present invention, the sectional difference portions 11, 12 include a first sectional difference portion 11 and a second sectional difference portion 12. The width of the first sectional difference portion 11 is larger than the width of the second sectional difference portion 12. Thus, it can be seen from FIGS. 2 and 3 that, the pitch between the grooves 10 of the first sectional difference portion 11 is larger than the pitch between the grooves 10′ of the second sectional difference portion 12.

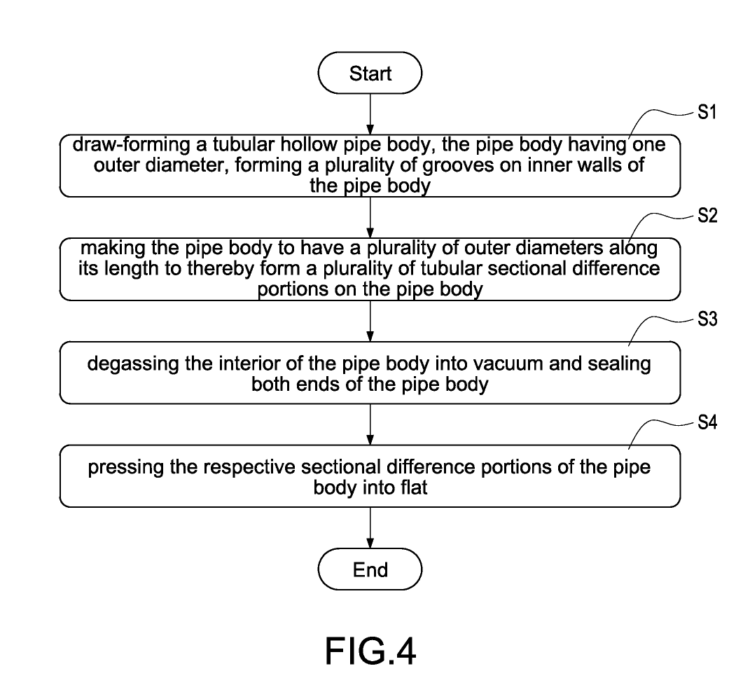

Please refer to FIG. 4 again. The present invention further includes a method for manufacturing a flat heat pipe with sectional differences, which includes the following steps.

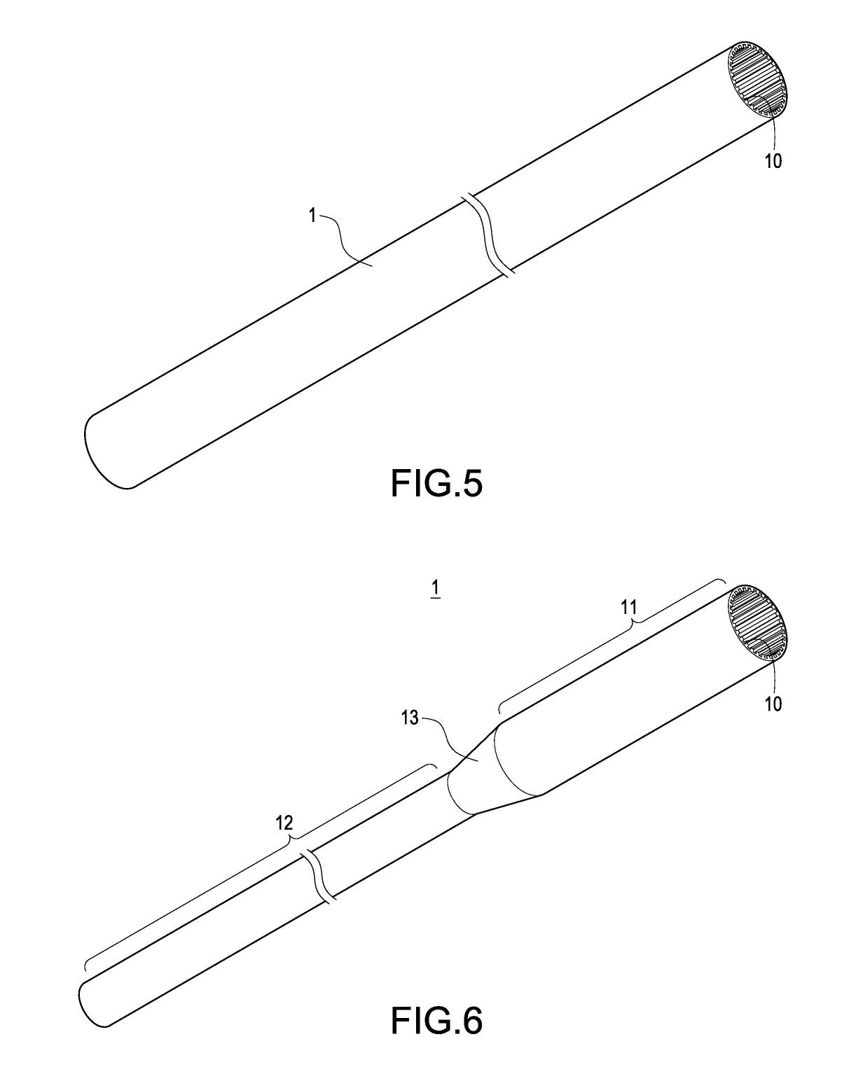

Please also refer to FIG. 5. In the step 51 of FIG. 4, a hollow tubular pipe body 1 is formed by a draw-forming process. The pipe body 1 has only one outer diameter, that is, the pipe body 1 has equal outer diameter throughout its length. During the draw-forming process of the pipe body 1, the inner wall of the pipe body 1 is formed with a plurality of grooves 10.

Please also refer to FIG. 6. In the step S2 of FIG. 4, a pipe body 1 is made to have at least two outer diameters, whereby the pipe body 1 is formed with a plurality of tubular sectional difference portions 11 and 12. Any one or a part of the sectional difference portions 11 and 12 is widen or narrowed by a pipe-widening process or a pipe-narrowing process. In this way, the pipe body 1 can be formed along its length with two sectional difference portions 11, 12 of different outer diameters. In the present embodiment of the present invention, the second sectional difference portion 12 is narrowed by a pipe-narrowing process, so that the outer diameter of the second sectional difference portion 12 is smaller than the outer diameter of the first sectional difference portion 11. In this way, the pipe body 1 can be formed with two sectional difference portions 11 and 12 of difference diameters. Of course, the first sectional difference portion 11 may be widened by a pipe-widening process. In other words, in the present step, not only any one or part of the second sectional difference portion 12 is narrowed, but also the first sectional difference portion 11 may be widened. Alternatively, any one or part of the first sectional difference portion 11 may be widened, and the un-widened second sectional difference portion 12 is narrowed. In this way, the difference between the outer diameters of the first and second sectional difference portions 11, 12 can be increased.

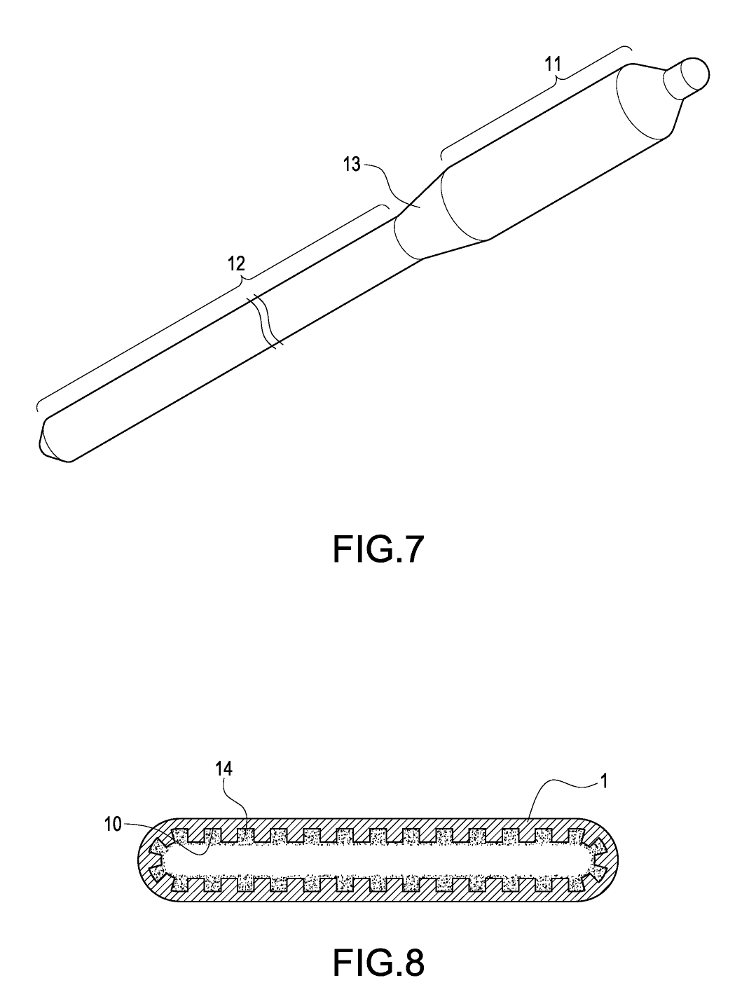

Please also refer to FIG. 7. In the step S3 of FIG. 4, the interior of the pipe body is degassed to become vacuum and its both ends are sealed. More specifically, a working fluid is sealed in the pipe body, and the gas (usually the gas unable to be condensed) is drawn out to become vacuum. The open end(s) of the pipe body is pressed and sealed. Alternatively, the open end(s) of the pipe body is sealed by a welding process.

In the step S1 of FIG. 4, finally, the sectional difference portions 11, 12 of the pipe body 1 are pressed to become flat, so that the flat heat pipe with sectional differences as shown in FIG. 1 can be obtained.

Further, as shown in FIG. 8, after the pipe body 1 is formed with the plurality of sectional difference portions 11 and 12 in the step S2, the grooves 10 in the pipe body 1 are filled with metal powder. After subjected to a sintering process, the metal powder in the grooves 10 becomes sintered powder, thereby increasing its capillary force.

With the above constituents and steps, the flat heat pipe with sectional differences and the method for manufacturing the same can be obtained.

Thus, according to the present invention, since the pitch between the grooves 10 in the sectional difference portion 11 of a relatively large width is larger than the pitch between the grooves 10′ in the sectional difference 12 of a relatively small width, the sectional difference portion 11 having a relatively large width is configured to act as an evaporating portion of the heat pipe, which will be brought into thermal contact with a heat source. Such a flat structure has an increased surface area, so that the contact area with the heat source is also increased to dissipate more heat per unit time. Further, the larger surface area can generate a better heat-dissipating effect. The larger pitch between the grooves 10 helps to store greater amount of working fluid and to perform a heat-exchanging effect. The sectional difference portion 12 having a relatively small width is configured to act as a heat-transmitting portion of the heat pipe because the heat-transmitting portion does not need to have a large contact area. On the other hand, such a heat-transmitting portion may have to be bent or curved to dodge surrounding elements. Further, heat-dissipating pieces (not shown) may be connected to the heat-transmitting portion to increase its effect of condensing the vapor-phase working fluid flowing there through. Moreover, the dense grooves 10′ in the sectional difference portion 12 helps to increase the capillary force therein. Thus, the sectional difference portion 12 having a relatively small width is suitable for the heat-transmitting portion. Therefore, the evaporating portion and the heat-transmitting portion of the flat heat pipe can be reinforced based on the practical demands.

According to the above, the present invention really achieves the desired objects and solves the problems in prior art. Further, the present invention demonstrates novelty and inventive steps, which conforms to the requirements for an invention patient.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A method for manufacturing a flat heat pipe with sectional differences, including steps of:
a) draw-forming a tubular hollow pipe body, the pipe body having one outer diameter, forming a plurality of grooves on an inner wall of the pipe body;
b) making the pipe body to have a plurality of outer diameters along its length to thereby form a plurality of tubular sectional difference portions on the pipe body;
c) degassing the interior of the pipe body into vacuum and sealing both ends of the pipe body; and
(d) pressing the respective sectional difference portions of the pipe body into flat.

2. The method according to claim 1, wherein any one or part of the sectional difference portions is narrowed by a pipe-narrowing process in the step b).

3. The method according to claim 2, wherein an un-narrowed part of the sectional difference portions is widened by a pipe-widening process.

4. The method according to claim 1, wherein any one or part of the sectional difference portions is widened by a pipe-widening process in the step b).

5. The method according to claim 4, wherein an un-widened part of the sectional difference portions is narrowed by a pipe-narrowing process.

6. The method according to claim 1, wherein after the pipe body is formed with the plurality of sectional difference portions in the step b), metal powder is filled in each groove of the pipe body, the metal powder is sintered to become sintered powder.
